(19) United States
(12) Patent Application Publication
(10) Pub. No.: US 2023/0144946 A1
(43) Pub. Date: May 11, 2023

(54) METHOD FOR SPLITTING SHARES AND GENERATING LAND REGISTRATION MAP AND ADDRESS FOR ASSETS OF WHICH OWNER CANNOT BE SPECIFIED OR OWNERSHIP DOES NOT EXIST, AND SYSTEM THEREFOR

(71) Applicants: Eun Ha SONG, Seoul (KR); Ja Ryong GOO, Seoul (KR)

(72) Inventors: Eun Ha SONG, Seoul (KR); Ja Ryong GOO, Seoul (KR)

(21) Appl. No.: 17/917,550

(22) PCT Filed: Apr. 7, 2021
(86) PCT No.: PCT/KR2021/004312

§ 371 Date: Oct. 6, 2022

(30) Foreign Application Priority Data
Apr. 7, 2020 (KR) 10-2020-0041952
Apr. 7, 2020 (KR) 10-2020-0154559

(51) Int. Cl. G06Q 50/16; G06Q 50/26

(52) U.S. Cl. CPC G06Q 50/163; G06Q 50/26

(57) ABSTRACT

The present inventive concept relates to a method for splitting shares and generating a land registration map and address for assets of which owner cannot be specified or ownership does not exist, and a system therefor, and provides a method for splitting common assets of which owner cannot be specified or does not exist into a plurality of units of shares, generating a land registration map for the shares, and generating an address for the generated land registration map, and a system therefor, thereby registering each of the plurality of units of shares split from the common assets with the generated land registration map and address, by recording same on a blockchain.

### TECHNICAL FIELD

The present disclosure relates to a method for splitting shares and generating a land registration map and address for assets of which owner cannot be specified or ownership does not exist, and a system therefor, and in more detail, provides a method for splitting common assets of which owner cannot be specified or does not exist, into a plurality of units of shares, generating a land registration map for the shares, and generating an address for the generated land registration map, and a system therefor, thereby registering each of the plurality of units of shares split from the common assets with the generated land registration map and address, by recording the same on a blockchain.

### BACKGROUND ART

In general, Antarctica, the Arctic or deep-sea floor of the Earth, planets such as the Moon, Mercury, Mars, etc. in space are common assets of mankind that do not have ownership of any specific country or company.

Since there is no owner and the owner cannot be specified in these common assets, these common assets are not subject to diversion by use, occupation, or possession by a specific country or company.

That is, since there is no method for recognizing the ownership of the common assets or a management system for the ownership, states or companies are fighting for a greater share in case of the common assets having abundant resources such as minerals and fish stocks.

Since these fights are mostly directed towards improving only the pursuit of their own interests, they are escalated into wars and contain problems that can cause great damages to mankind For the purpose of preventing these problems in advance, there is a need for an appropriate system for the privatization and sharing ecosystem of the common assets.

Accordingly, in order to solve the above problems, the present inventive concept suggests a method for equally splitting common assets of which owner cannot be specified or does not exist, into a plurality of units of shares, generating a land registration map for the shares of the common assets, generating an address for each of units of shares of the generated land registration map, allowing a user to obtain a share on the generated land registration map based on the generated address, and thereby enabling his own share for the common asset to be simply registered.

That is, the present inventive concept relates to a system and method for splitting the common asset into a plurality of unit-shares, creating a land registration map for the unit-share, providing an address to each share in the created land registration map, and thereby registering each of the plurality of units of shares split from the common asset with the generated land registration map and address, by recording the same on a blockchain.

Hereinafter, the prior art existing in the technical field of the present inventive concept is briefly described, and then the technical matters that the present inventive concept intends to achieve differently from the prior art are described.

First, Korean Patent Publication No. 2009-0000782 (2009 Jan. 8) relates to a new address designation method, especially relates to a method of designating a new address consisting of a road name and a building number for each building, by receiving the location information of the main road, link, and building, designating a link that is in contact with a link belonging to the main road and does not belong to the main road as a representative link, designating a unit by combining the representative link of the nearest main road from the connecting link connected to the representative link, then assigning a branch number and a building number to the main road and a building adjacent to the main road, assigning a building number to the building adjacent to the unit, designating the address of each building in the form of city, county name, main road name, branch number and building number.

It is characterized in that the prior art designates a new address for each building including the road name and building number based on the main road.

However, the present inventive concept does not assign an address for a specific building, but relates to a method for generating a land registration map for a common asset of which owner cannot be specified or ownership does not exist, and generating an address for each of unit-shares of the generated land registration map, so that a user can acquire a share on the generated land registration map and enables the acquired his own share to be simply registered as his own share, and thus there are significant differences between the prior art and the present inventive concept.

In addition, Korean Patent Registration No. 1777060 (2017 Sep. 4) relates to a device and method for generating an address in an Internet of Things system, which extracts a conversion target identifier including a manufacturer identifier, a model identifier and a serial number from the OID (object identifier) address assigned to the IoT device, generates a first MAC address by converting each of the extracted conversion target identifiers into hexadecimal numbers expressed as bits of 4 units, generates a second MAC address by adding 16 bits between the area including the manufacturer identifier and the area including the model identifier in the generated first MAC address, and then generating an IP address by mapping the generated second MAC address to an IPv6 address form by using an interface ID.

The prior art is to generate a MAC address and an IP address for the IoT device, based on the OID assigned to the IoT device, which is clearly different from the present inventive concept, which creates a land registration map (i.e., a land registration map) for a common asset of which owner cannot be specified or does not exist and generates an address for each unit-share on the generated land registration map.

### DISCLOSURE

### Technical Problem

The present inventive concept was devised to solve the above problems, it is an objective for the present inventive concept to provide a method and system for enabling a user obtain a share on the land registration map and register the obtained share as his own share according to the address of the generated share., by equally splitting a common asset of which owner cannot be specified or does not exist, into a plurality of units of shares, generating a land registration map for the plurality of units of split shares, generating an address for the generated land registration map.

It is another objective for the present inventive concept to provide a method and system for efficiently generating the entire land registration map for the common asset, by generating a land registration map for each sector by grouping the land registration map for each unit-share or the land registration map for each area t, after generating at least one or more land registration map for each area by grouping the land registration map for each unit-share.

It is another objective for the present inventive concept to provide a method and system for generating addresses for the split plurality of unit-shares, respectively, by allocating a unique identifier for each unit-share to each unit-share, wherein a common asset identifier is assigned to the common asset, a sector identifier is assigned to the sector grouped by zones, a zone identifier is assigned to the zone grouped by unit-shares, and a share identifier is assigned to the unit-share.

It is another objective for the present inventive concept to provide a method and system for generating address addresses for the divided plurality of unit-shares, respectively, by additionally allocating a personal identifier input from a specific user to an address for a specific unit-share, when the specific user registers as his own share for a specific unit-share.

It is another objective for the present inventive concept to provide a public registration for each unit-share of a common asset of which owner cannot be specified or does not exist, such as planets such as the moon, Mercury or Mars, or areas such as Antarctic, Arctic, or deep sea of the Earth.

### Technical Solution

It is characterized in that a system for registering an asset of which owner cannot be specified or ownership does not exist, in a blockchain by splitting the asset into a share and creating a land registration map and address of the share, according to an embodiment of the present inventive concept, the system comprises a blockchain node with a processor configured to: split the asset into a plurality of unit-shares according to a predetermined splitting rule; create the land registration map for each of the plurality of split unit-shares in the form of a cell with a specific shape on a map or a model for the asset; and create an address by assigning a unique identifier to each of the plurality of split unit-shares, wherein the asset is the one of which owner cannot be specified or ownership does not exist, and the created unit-share, the land registration map, and the address are respectively the unit-share-on-the-blockchain, the land registration map-on-the-blockchain, and the address-on-the-blockchain, and wherein the system is configured to: record the unit-share-on-the-blockchain, the land-registration-map-on-the-blockchain, and the address-on-the-blockchain in the blockchain, and thereby granting public confidence to each of the registered unit-shares by shareholders-on-the-blockchain previously participating in the blockchain.

Wherein it is characterized in that the processor is further configured to: create a zone by grouping at least one or more split unit-shares and classify a sector by grouping at least one or more zones, and thereby registering the zone and the sector by recording the zone and the sector in the blockchain.

Wherein it is characterized in that the processor is further configured to: create a land registration map for each zone by grouping the land registration map created for each of the unit-shares, creating a land registration map for each sector by grouping the land registration map created for each of unit-shares or the created land registration map for each of zones, and thereby registering the land registration map for the entire asset by recording the land registration map for the entire asset in the blockchain.

Wherein it is characterized in that the processor is further configured to: create an address for each of the plurality of split unit-shares, by assigning a unique identifier to each unit-share, wherein the unique identifier includes a zone identifier assigned to a corresponding zone that each unit-share is grouped, a sector identifier assigned to a corresponding sector that each zone is grouped, and an asset identifier assigned to the asset itself.

Wherein it is characterized in that the unique identifier comprises each unit-share identifier assigned to the plurality of split unit-shares, and the address is composed by additionally assigning an input personal identifier to the unique identifier assigned for a specific unit-share, wherein the input personal identifier is entered by a user for the registration, when the user registers ownership of the specific unit-share among a plurality of unit-shares previously recorded and registered in the blockchain.

Wherein it is characterized in that the processor is further configured to: create a unit-share ledger for each split unit-share including the created land registration map, location information of each split unit-share located on the created land registration map, and the address created for each unit-share; and register each split unit-share in the blockchain by obtaining an endorsement from at least one or more of blockchain nodes for the created unit-share ledger, and creating a block for each unit-share ledger and recording the block in the blockchain, wherein the created block is connected to the blockchain based on a hash value obtained by hashing the address created for each unit-share and distributed and stored in the at least one or more of blockchain nodes.

Wherein it is characterized in that the asset is the one of which owner cannot be specified or does not exist, comprising a planet including Mars, Mercury, or the Moon; a specific area of the Earth, including the South Pole, the North Pole, or deep sea; or a combination thereof.

Meanwhile, it is characterized in that a method for registering an asset of which owner cannot be specified or ownership does not exist, in a blockchain by splitting the asset into a share and creating a land registration map and address of the share, the method comprises: in a system for registering the asset, splitting the asset into a plurality of unit-shares according to a predetermined splitting rule; in the system for registering the asset, creating the land registration map for each of the plurality of split unit-shares in the form of a cell with a specific shape on a map or a model for the asset; and in the system for registering the asset, creating an address by assigning a unique identifier to each of the plurality of split unit-shares, wherein the asset is the one of which owner cannot be specified or ownership does not exist, and the created unit-share, the land registration map, and the address are respectively the unit-share-on-the-blockchain, the land registration map-on-the-blockchain, and the address-on-the-blockchain, and wherein the method comprises recording the unit-share-on-the-blockchain, the land-registration-map-on-the-blockchain, and the address-on-the-blockchain in the blockchain, and thereby granting public confidence to each of the registered unit-shares by shareholders-on-the-blockchain previously participating in the blockchain.

Wherein it is characterized in that the splitting of the unit-share further comprises: creating a zone by grouping at least one or more split unit-shares and classify a sector by grouping at least one or more zones, and thereby registering the zone and the sector by recording the zone and the sector in the blockchain.

Wherein it is characterized in that the creating of the land registration map further comprises: creating a land registration map for each zone by grouping the land registration map created for each of the unit-shares, creating a land registration map for each sector by grouping the land registration map created for each of unit-shares or the created land registration map for each of zones, and thereby registering the land registration map for the entire asset by recording the land registration map for the entire asset in the blockchain.

Wherein it is characterized in that the creating of the address further comprises: creating an address for each of the plurality of split unit-shares, by assigning a unique identifier to each unit-share, wherein the unique identifier includes a zone identifier assigned to a corresponding zone that each unit-share is grouped, a sector identifier assigned to a corresponding sector that each zone is grouped, and an asset identifier assigned to the asset itself.

Wherein it is characterized in that the method further comprises: creating a unit-share ledger for each split unit-share including the created land registration map, location information of each split unit-share located on the created land registration map, and the address created for each unit-share; and registering each split unit-share in the blockchain by obtaining an endorsement from at least one or more of blockchain nodes for the created unit-share ledger, and creating a block for each unit-share ledger and recording the block in the blockchain, wherein the created block is connected to the blockchain based on a hash value obtained by hashing the address created for each unit-share and distributed and stored in the at least one or more of blockchain nodes, and wherein the asset is an asset of which owner cannot be specified or does not exist, comprising a planet including Mars, Mercury or the Moon; a specific area of the Earth, including the South Pole, the North Pole, or the deep sea; or combinations thereof.

### Advantageous Effects

As described above, it has effect that the method and system for splitting shares of a common asset and creating a land registration map and address, of the present inventive concept, split a common asset if which owner cannot be specified or does not exist, into equally sized unit-shares, create a land registration map for the common asset based on the split unit-shares, assigning a unique identifier to each split share, and additionally assigning a user identifier provided by the user who has acquired each of the unit-shares, creating an address for each unit-share, and register to record each unit-share of the common asset in the blockchain, thereby systematically managing ownership of each of the unit-shares, and granting public confidence to the ownership of the corresponding share.

### DESCRIPTION OF DRAWINGS

FIG. 1 shows a conceptual diagram for explaining a method and system for splitting shares and creating a land registration map and an address for an asset of which owner cannot be specified or ownership does not exist, according to an embodiment of the present inventive concept.

FIG. 2 shows a diagram for explaining the flow of a process of registering a unit-share for a common asset in a blockchain node according to an embodiment of the present inventive concept.

FIG. 3 shows a view showing a land registration map according to an embodiment of the present inventive concept.

FIG. 4 shows a view showing a land registration map according to another embodiment of the present inventive concept.

FIG. 5 shows a diagram illustrating a process of generating an address for a unit-share according to an embodiment of the present inventive concept.

FIG. 6 shows a block diagram showing the configuration of a blockchain node according to an embodiment of the present inventive concept.

FIG. 7 shows a flowchart illustrating share splitting, land registration map and address creating procedures for an asset of which owner cannot be specified or ownership does not exist according to an embodiment of the present inventive concept.

FIG. 8 shows a diagram showing a hardware architecture for a blockchain node according to an embodiment of the present inventive concept.

### DETAILED DESCRIPTION

Hereinafter, preferred embodiments of a system and method for splitting shares, creating land registration maps and addresses for an asset of which owner cannot be specified or ownership does not exist of the present inventive concept are described in detail with reference to the accompanying drawings. The same reference numerals indicate the same elements in each drawing. In addition, specific structural or functional descriptions for the embodiments of the present inventive concept are only exemplified for the purpose of describing the embodiments according to the present inventive concept, unless defined otherwise, all terms used herein, including technical or scientific terms, have the same meaning as commonly understood by one of ordinary skill in the art to which the present inventive concept belongs. Terms such as those defined in a commonly used dictionary should be interpreted as having a meaning consistent with the meaning in the context of the related art, unless defined herein the present specification, it is desirable not to be interpreted in an idealistic or overly formal sense.

Hereinafter, the overall blockchain network configuration for splitting shares, and creating a land registration map and address for an asset of which owner cannot be specified or ownership does not exist is described in detail.

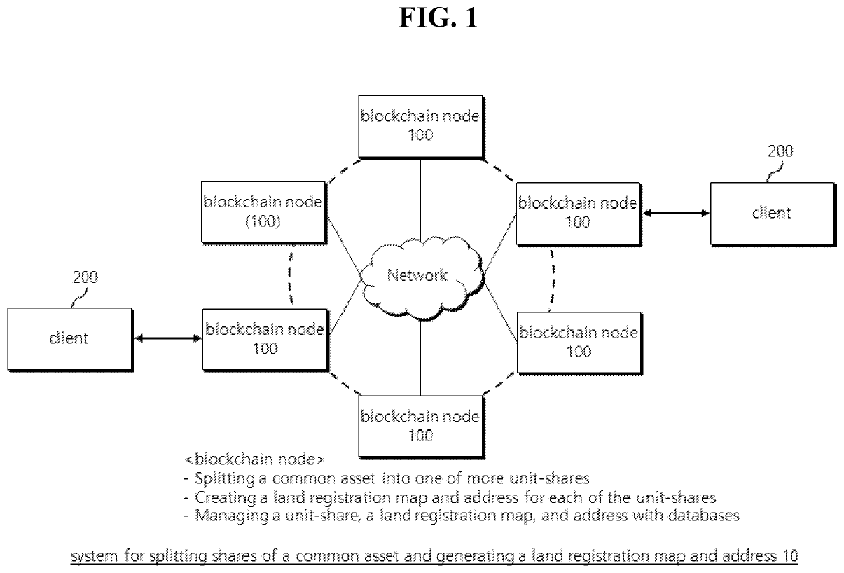

FIG. 1 shows a conceptual diagram for explaining a method and system for splitting shares and creating a land registration map and an address for an asset of which owner cannot be specified or ownership does not exist, according to an embodiment of the present inventive concept.

As shown in FIG. 1, a system for splitting shares and creating a land registration map and an address for a common asset 10 according to an embodiment of the present inventive concept, comprises a plurality of blockchain nodes 100 for forming a blockchain, at least one or more clients 200 connecting to each of the blockchain nodes 100, and a database (300) connected to the plurality of blockchain nodes 100, respectively.

The blockchain node 100 splits the common asset into a plurality of unit-shares, creates a land registration map for the common asset based on the split plurality of unit-shares, creates an address for the unit-share, and then obtains an endorsement for the unit-share of which the land registration map and address are created, from other plurality of blockchain nodes 100. Thereafter, the blockchain node 100 generates a block for each of the endorsed plurality of unit-shares, links each of the generated blocks with a chain, records the plurality of unit-shares in the blockchain thereby registering the plurality of unit-shares, propagates each of the blocks to the plurality of blockchain nodes 100 thereby sharing each of the blocks, and thus each of the unit-shares can be managed by the blockchain in each of the blockchain nodes 100.

Through the above process, the plurality of blockchain nodes 100 allows the user to identify the unit-share on the land registration map, to acquire ownership of at least one or more unit-shares according to the created address, and to make it easy to register the acquired ownership. Through this process, public confidence is granted to each corresponding share.

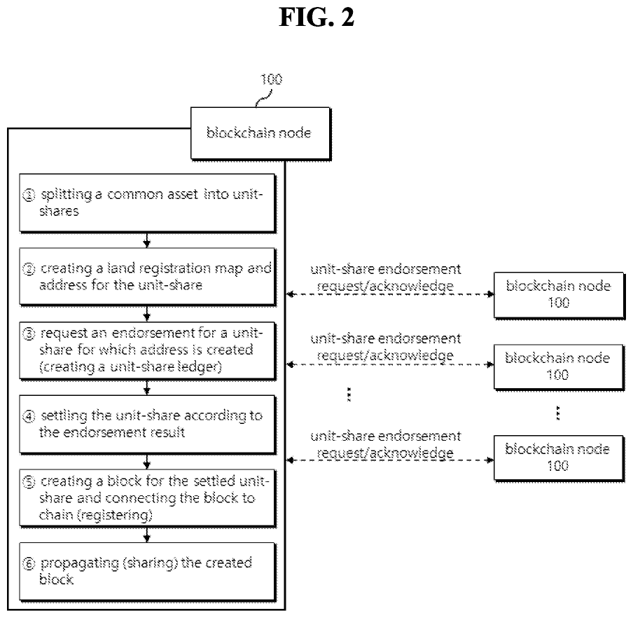

That is, the plurality of blockchain nodes 100 record to register each unit-share in the blockchain, so that they support a function of registering the acquired ownership according to the address created for the specific unit-share by a user who has acquired ownership of the specific unit-share through a trade between parties. On the other hand, splitting a common asset into a plurality of unit-shares, and creating a land registration map and an address for the unit-share are key technical features of the present inventive concept, and will be described in detail with reference to FIG. 2 to FIG. 5.

Where the registration function is performed in the plurality of blockchain nodes 100. However, the creation of the address for the land registration map and the unit-share is preferably performed in one specific blockchain node 100, but there is no such limit in the present inventive concept, and it may be implemented to create an address for the land registration map and the unit-share in at least one or more blockchain nodes 100.

Each of the plurality of blockchain nodes 100 may be physically configured as one independent system or server, and the physically configured blockchain node 100 may be virtualized into at least one or more blockchain nodes 100 and may be configured as a plurality of virtual nodes. At this time, the blockchain node 100 that is physically configured or configured as the virtual node is implemented to have an independent IP address.

The client 200 refers to a program installed in a user terminal allowing a user to access the blockchain node 100, wherein the user includes a person who wants to register ownership through a trade for a unit-share, an administrator who manages the system for splitting shares of a common asset and creating a land registration map and an address 10, etc. Therefore, the user accesses any one of the blockchain nodes 100 through the client 200, and can use a function (i.e., registration) supported by the system for splitting the shares of the common asset and creating the land registration map and address 10.

Each of the plurality of blockchain nodes 100 comprises a database 300 including a land registration map database 310 for classifying and managing the created land registration map by each common asset, an address database 320 for managing addresses created for each unit-share on the land registration map, a unit-share database 330 for managing each of the split plurality of unit-shares and a blockchain database 340 for managing the unit-share registered based on a blockchain, and a management database (not shown) for managing information for each user. While the database 300 is preferably implemented in the cloud, it is natural that it may be locally implemented in each of the blockchain nodes 100.

The common asset refers to an area or an asset of which owner cannot be specified or does not exist, comprising a planet including Mars, Mercury or the Moon, and a specific area of the Earth, including the South Pole, the North Pole, or the deep sea; or combinations thereof.

Hereinafter, processes of splitting a common asset into a plurality of unit-shares and creating a land registration map and address for each of the split unit-shares and managing the unit-shares with a blockchain in the blockchain node 100 will be described.

FIG. 2 shows a diagram for explaining the flow of a process of registering a unit-share for a common asset in a blockchain node according to an embodiment of the present inventive concept.

As shown in FIG. 2, the blockchain node 100 according to an embodiment of the present inventive concept is configured to create a land registration map for a common asset, create an address for the unit-share on the land registration map based on the created land registration map, thereby facilitating to acquire a share including at least one or more unit-shares on the land registration map according to the created address and to register ownership for the share. To this end, the blockchain node 100 first splits the common asset into a plurality of unit-shares (\textcircled{1}).

Wherein, the splitting into the plurality of unit-shares means equally splitting the common asset, for example, a splitting rule may be set in advance so that the common asset is equally split into a specific area (e.g., 10 square meters). In this case, the unit-share is shown in the form of a cell having a shape (ex: a triangle, a square, a pentagon, a hexagon, etc.), so as to have a boundary according to the splitting rule on the land registration map.

The blockchain node 100 is configured to create a land registration map indicating the plurality of split unit-shares, and create an address on the created land registration map (\textcircled{2}).

Wherein, the land registration map is created by showing the unit-share in the form of a cell on a map of the common asset or a model modeling the common asset, such that each of the plurality of unit-shares of which the common asset is equally split has a boundary with each other.

The address is also created by allocating an identifier to each of the plurality of unit-shares. That is, the address is for distinguishing each of the split plurality of unit-shares, in case of a movable common asset, the process of creating the land registration map is omitted, each of the plurality of unit-shares in which the movable common asset is split is distinguished by allocating an identifier to each of the plurality of unit-shares in which the movable common asset is split. Hereinafter, generating an address for each of a plurality of unit-shares that the common asset is split will be described as a concept including allocating an identifier to each of a plurality of unit-shares that the movable asset is split.

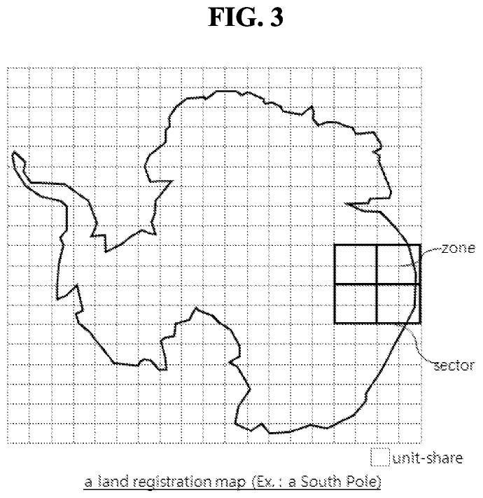

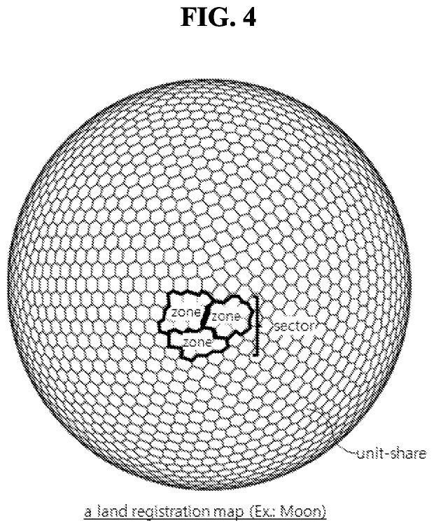

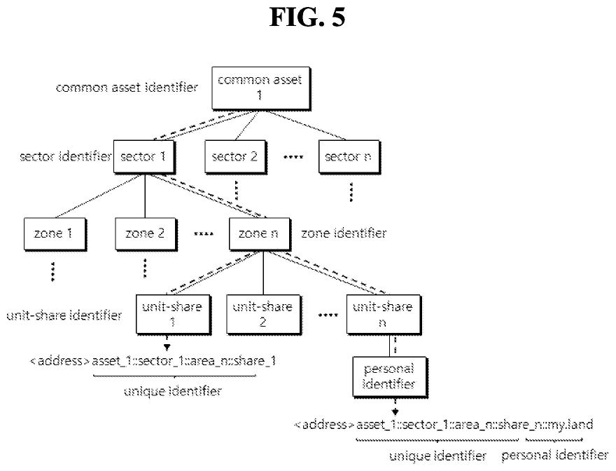

Meanwhile, the process of creating the land registration map and the process of creating the address will be described in detail with reference to FIG. 3, FIG. 4, and FIG. 5, respectively.

The blockchain node 100 requests an endorsement for the unit-share that created the land registration map and address to at least one or more blockchain nodes 100 (\textcircled{3}).

Wherein, the blockchain node 100 requests an endorsement for the plurality of unit-shares, by composing a unit-share ledger for each of the plurality of unit-shares and providing the composed unit-share ledger to the at least one or more blockchain nodes 100.

The composed unit-share ledger comprises the land registration map created for the corresponding unit-share, the entire land registration map created for the common asset, and location information (e.g., latitude, longitude, or x-y coordinate) for the unit-share located on the created land registration map and the address created for the unit-share located on the created land registration map.

The blockchain node 100 participating in endorsement for a plurality of unit-shares confirms whether there is a reason for disqualification for the plurality of unit-shares according to the endorsement procedure set in advance and transmits the confirmed result to the blockchain node 100 that has requested an endorsement for the plurality of unit-shares.

The endorsement procedure comprises processes for whether the common asset has been split according to the pre-established splitting rules, whether the created land registration map is created according to the previously set land registration map creation rules, whether the address is crested according to the address creation rule set in advance, whether a land registration map for the same common asset has already been created, and whether the created address has already been created, by confirming the created each unit-share ledger.

After that, at least one or more blockchain nodes 100 participating in the endorsement sign the confirmed result, provide the endorsement result for each of the plurality of unit-shares to the blockchain node 100 that has requested the endorsement for the unit-shares.

The blockchain node 100 determines each of the plurality of unit-shares by confirming the endorsement result, and determining the unit-share ledger for each of the plurality of unit-shares endorsed by all blockchain nodes 100 participating in the endorsement (\textcircled{4}).

The blockchain node 100 is configured to register the plurality of unit-shares by creating a block for each of the determined plurality of unit-share ledgers and connecting the created block to the blockchain (\textcircled{5}), and manage the common asset with a blockchain in each blockchain node 100 by propagating and sharing each of the created blocks to the at least one or more blockchain nodes 100 (\textcircled{6}).

In this case, the block is configured to comprise the land registration map created for the unit-share, the land registration map created for the entire common asset, location information for the corresponding unit-share located on the created land registration map, the address created for the unit-share, the hash value of the corresponding block, the hash value of the previous block connected by the chain, and the hash value of the subsequent block. In this case, the hash value of the block can be used as a hash value of the address created for the unit-share, or a hash value hashing the unit-share ledger. That is, each of the blocks is configured to connect the plurality of unit-shares with a chain by including the hash values of the previous and subsequent blocks, and thus forming a blockchain for each of the plurality of unit-shares.

Each of the plurality of registered unit-shares is recognized for fairness and public confidence through the process of requesting and confirming the endorsement for such unit-shares. The creation of the share is recognized for the fairness and public confidence from the blockchain, thereby securing trust from the public.

FIG. 3 shows a view showing a land registration map according to an embodiment of the present inventive concept, and FIG. 4 shows a view showing a land registration map according to another embodiment of the present inventive concept.

As shown in FIG. 3, the land registration map according to an embodiment of the present inventive concept is configured to comprise a unit-share, a sector and a zone. If the common asset is a terrestrial area (e.g., Antarctica), a land registration map for the common asset is created based on the unit-share in which the common asset is split based on a map (e.g., a ground map, GIS map, etc.) of the corresponding common asset. Wherein the blockchain node 100 that creates the land registration map creates a land registration map for each of the split plurality of unit-shares. The land registration map for each unit-share is created by showing each unit-share on the map in the form of a cell having a shape of a specific figure according to a criterion (e.g., a specific area) for evenly splitting the common asset. The cell represents each of the plurality of unit-shares, and is composed of a triangle, a square, a pentagon, a hexagon, or a combination thereof.

The blockchain node 100 is configured to split the common asset by partitioning the plurality of unit-shares into at least one or more zones by grouping at least one or more the created land registration map for each unit-share into at least one or more groups and by classifying the at least one or more zones into at least one or more sectors by grouping the at least one or more zones into at least one or more sectors, create the entire land registration map by creating a land registration map for each unit-share of the common asset, creating a land registration map for each zone by grouping the land registration map for each unit-share, and then create a land registration map for each sector by grouping the land registration map for each share or zone.

The blockchain node 100 is configured to, when creating the land registration map, create the land registration map for each unit-share according to the previously set land registration map creation rule. Wherein the land registration map creation rule refers to the order of creating the land registration map for each unit-share, creating a land registration map for the unit-share in order while extending from the central coordinates of the map, or creating the land registration map for the unit-share in order while expanding based on the rotation axis of the model. These land registration map creation rules may be set differently for each common asset.

On the other hand, as shown in FIG. 4, in case that a map for the common asset does not exist (e.g., a planet such as the moon), a land registration map for the common asset is created based on a model modeling the common asset. The process of creating the land registration map for the common asset based on the model is the same as the process of creating the land registration map with reference to FIG. 3.

FIG. 5 shows a diagram illustrating a process of generating an address for a unit-share according to an embodiment of the present inventive concept.

As shown in FIG. 5, the blockchain node 100 according to an embodiment of the present inventive concept is configured to equally split the common asset into a plurality of respective unit-shares and create an address for each of the split unit-shares.

Wherein the blockchain node 100 is configured to partition the equally split at least one or more unit-shares into the at least one or more zones by grouping the equally split at least one or more unit-shares and classify the at least one or more zones into at least one or more sectors by grouping the at least one or more zones.

The blockchain node 100 is configured to assign an identifier for each common asset, each classified sector, each partitioned zone, and each of the plurality of unit-shares.

Thereafter, the blockchain node 100 is configured to create an address by linking and allocating an identifier assigned to each sharer, an identifier assigned to each sector, identifier assigned to each zone and identifier assigned to each unit-share.

The blockchain node 100 is configured to allow a user to acquire a specific unit-share of at least one or more unit-share through a trading, to perform ownership registration or ownership transfer registration for the unit-share, to enter a personal identifier for the corresponding unit-share, then the blockchain node 100 is configured to additionally allocate the input personal identifier to the address for each of the created unit-shares and finally create a user's own address for the unit-share in which the registration is performed.

In this case, the common asset identifier, the sector identifier, the zone identifier, and the unit-share identifier become unique identifiers of each unit-share. In addition, although it is shown in FIG. 5 that the personal identifier input by the user is allocated after the unique identifier, it goes without saying that the personal identifier may be assigned before the unique identifier.

Each of the identifiers may be composed of a binary number, a letter, a decimal number, a special character, or a combination thereof.

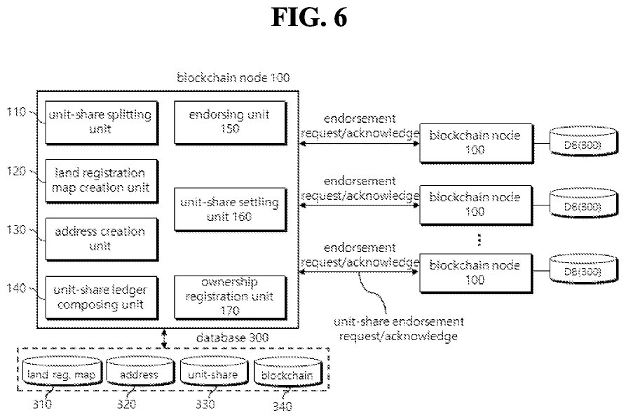

FIG. 6 shows a block diagram showing the configuration of a blockchain node according to an embodiment of the present inventive concept.

As shown in FIG. 6, the blockchain node 100 according to an embodiment of the present inventive concept is configured to comprise: a unit-share splitting unit 110 configured to split a common asset into a plurality of unit-shares; a land registration map creation unit 120 configured to create a land registration map for each of the split plurality of unit-shares, an address creation unit 130 configured to create addresses for each of the plurality of unit-shares on the created land registration map, a unit-share ledger composing unit 140, an endorsement unit 150, a unit-share settling unit 160 configured to register and confirm each of the plurality of unit-shares, and a ownership registration unit 170 configured to register ownership of a user with respect to the specific unit-share by the specific user purchasing a specific unit-share through a trade.

The unit-share splitting unit 110 is configured to equally split the common asset into a plurality of unit-shares according to a preset splitting rule (i.e., unit size of an area).

Wherein, the unit-share splitting unit 110 is configured to partition the plurality of split unit-shares into at least one or more zones by grouping the at least one or more split unit-shares and classifying the at least one or more zones into at least one or more sectors by grouping the at least one or more zones. That is, at least one or more unit-shares among the plurality of unit-shares belong to a specific zone, at least one or more zones among the plurality of zones belong to a specific sector.

On the other hand, in case that the common asset is a movable asset such as gold, securities, etc., the unit-share splitting unit 110 is configured to equally split the movable asset into a plurality of unit-shares according to a splitting rule (i.e., unit amount of value) that sets the total value of the movable asset in advance.

The land registration map creation unit 120 is configured to create a land registration map for the common asset based on a plurality of unit-shares split by the common asset, and not create a land registration map for the movable asset in case that the common asset is movable asset, as described above.

The land registration map creation unit 120 is configured to create a land registration map for each unit-share by indicating each of the plurality of unit-shares having a figure type cell on a map or model of a corresponding common asset, according to a predetermined land registration map creation rule. In addition, the land registration map creation unit 120 is configured to create a land registration map for the entire common asset, by creating a land registration map for each area by grouping the land registration map for each unit-share, and by creating a land registration map for each sector by grouping the land registration map for each unit-share or each zone.

The cell represents a unit-share on the land registration map, the unit-share on the land registration map is indicated to have boundaries with other unit-shares. Since the process of creating the land registration map has been described with reference to FIG. 3 and FIG. 4, further detailed description is omitted.

The address creation unit 130 is configured to create an address for each of the plurality of unit-shares on the created land registration map. Wherein it is preferable that the address is created according to the land registration map creation order for each unit-share.

The address creation unit 130 is configured to assign a common asset identifier for the common asset, a unit-share identifier for each of the plurality of unit-shares, a zone identifier for each zone in which each of one or more unit-shares is grouped, a sector identifier for each sector in which each of one or more zones is grouped.

The address creation unit 130 is configured to create addresses for the split plurality of unit-shares, by allocating a unique identifier for each of the plurality of unit-shares to each unit-share, wherein the unique identifier includes the common asset identifier, the zone identifier, the sector identifier, and the unit-share identifier provided above.

In case that the user acquires the specific unit-share through the trade, registers ownership of the unit-share, and enters the personal identifier used for registering the ownership, the address creation unit 130 is configured to further comprise creating addresses for a registered specific unit-share by additionally allocating the entered personal identifier to the address (i.e., a unique identifier) created for the specific unit-share.

Meanwhile, since the creation of the address for each of the plurality of unit-shares has been described in detail with reference to FIG. 5, further detailed description is omitted.

The unit-share ledger composing unit 140 is configured to compose a unit-share ledger for each of the split plurality of unit-shares.

The composed unit-share ledger comprises the land registration map created for the unit-share, the overall land registration map created for the common asset, and the location coordinates of the unit-share located on the overall land registration map (e.g., latitude and longitude or x, y coordinates) and addresses created for the corresponding unit-shares.

The endorsing unit 150 is configured to perform an endorsement for each unit-share according to an endorsing procedure for each of the plurality of unit-share ledgers. And the endorsing unit 150 is configured to request the endorsement for each of the unit-shares by providing each of the created plurality of unit-share ledgers to at least one or more blockchain nodes 100 that perform the endorsement, when each unit-share ledger is composed.

Wherein the blockchain node 100 performing each of the endorsements is configured to identify the respective unit-share ledger in accordance with the endorsing procedure set in advance, if there is no reason for disqualification for the unit-share, create a signature for the unit-share, and provide the signature to the blockchain node 100 that has requested the endorsement. Meanwhile, since the endorsing procedure has been described with reference to FIG. 2, further detailed description is omitted.

When the unit-share settling unit 160 is configured to receive a signature for the unit-share from all blockchain nodes 100 that have been requested for the endorsement, settles each of the plurality of unit-share ledgers, thereby settling the split plurality of unit-shares.

Thereafter, the unit-share settling unit 160 is configured to create a block for each of the settled plurality of unit-share ledgers, connect each of the created blocks with a chain, and thus registering the each of the plurality of unit-shares by recording the each of the plurality of unit-shares in a blockchain.

The unit-share settling unit 160 is configured to enable each unit-share to be managed by the blockchain node 100 in the blockchain by propagating and sharing the settled block for each unit-share ledger to the at least one or more blockchain nodes 100, the created land registration map for each unit-share, the overall land registration map created for the common asset, and the created address for each unit-share to be provided to each blockchain node 100 so that they can be managed in a distributed manner

Wherein it is preferable that the block is created according to the creation order for the land registration map for each unit-share, a hash value of the corresponding block, a hash value of a previous block connected to the corresponding block with a chain, a hash value of a subsequent block connected to the corresponding block with the chain, an address of the corresponding unit-share, a land registration map of the corresponding unit-share, an entire land registration map of the common asset, location information of the corresponding unit-share located on the entire land registration map, and a zone and sector to which the corresponding unit-share belongs are recorded in the block.

When a specific user acquires ownership for a specific unit-share by trading the specific unit-share, the ownership is registered by updating the block. The updating of the block is performed by additionally recording the user information (i.e., buyer information) of the corresponding user, the seller information who sold the specific share, the address for the specific share to which the personal identifier entered by the user is assigned, and the registration date in the block.

That is, the present inventive concept allows the unit-share to be managed by a blockchain, allows users to acquire at least one unit-share, and thus allows the user's ownership of the acquired unit-share to be easily registered according to the created generated address.

The ownership registration unit 170 is configured to be operated when at least one specific unit-share is purchased by a specific user through a trading between parties and the ownership of the specific user for the specific unit-share is registered.

On the other hand, the trading means a transaction between parties for transferring ownership of the unit-share. When trading a unit-share for which ownership is not registered, the parties become a user who wants to purchase the share and a blockchain node 100 to which the client 200 of the corresponding user are connected. In addition, when trading unit-shares with registered ownership, the parties are a user who wish to purchase the shares and a registrar whose ownership is registered.

That is, when a user who wants to purchase a unit-share through the trade selects an address for the corresponding unit-share, pays the fees (e.g., cash or crypto currency) for the trade, the trading is concluded, the ownership registration unit 170 updates the corresponding block of the unit-share managed by the blockchain by recording the registration information comprising information on the registration right holder (i.e., purchaser) for the specific unit-share for which the transaction is concluded, seller information registered as current ownership, address for the specific unit-share, the transaction cost and the registration date, and thus the ownership of the unit-shares purchased and acquired by the user is registered.

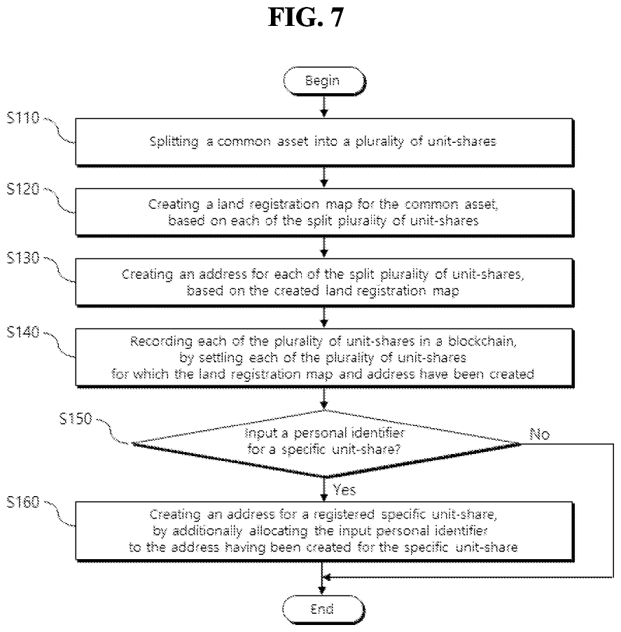

FIG. 7 shows a flowchart illustrating share splitting, land registration map and address creating procedures for an asset of which owner cannot be specified or ownership does not exist according to an embodiment of the present inventive concept.

As shown in FIG. 7, the procedure of creating an address of a land registration map and unit-share for the common asset according to an embodiment of the present inventive concept is first, in the blockchain node 100 of the system 10 for splitting the share of the common asset and generating the land registration map and address, performs splitting the common asset into a plurality of unit-shares (S110).

The splitting of a unit-share comprises equally splitting the common asset according to a splitting rule set in advance, partitioning the evenly split shares into at least one or more zones by grouping the at least one or more evenly split shares, and classifying the at least one or more zones into at least one or more sectors by grouping the at least one or more zones. That is, in principle, the common assets are equally split into the unit-shares.

Next, the blockchain node 100 comprises generating a land registration map for the common asset based on the split plurality of unit-shares (S120).

Wherein the generating of a land registration map comprises generating a land registration map for each unit-share of the common asset, creating a land registration map for each zone by grouping the land registration maps for each of shares, creating a land registration map for each sector by grouping the land registration maps for each unit-share or each zone, thereby creating an overall land registration map for the common asset. Wherein the unit-share on the land registration map for each unit-share is expressed as a cell with a specific shape, the land registration map for each unit-share is created to have boundaries without overlapping area with other land registration maps for each of unit-shares.

The land registration maps are sequentially created according to the land registration map creation rule set in advance, as described above.

Next, the blockchain node 100 performs creating an address for each unit-share on the created land registration map (S130).

Preferably, the address is created according to the order in which the land registration map for each unit-share is created, and the address is created by assigning a unique identifier to each unit-share including the common asset identifier assigned to the common asset itself, the sector identifier assigned to the sector, a zone identifier assigned to the zone, and the unit-share identifier assigned to the unit-share.

Next, the blockchain node 100 performs a unit-share settlement process of registering each of the plurality of unit-shares by settling a plurality of unit-shares that have created the land registration maps and the addresses and by recording each of the plurality of unit-shares in a blockchain (S140). The settlement is performed by generating a unit-share ledger for each of the plurality of unit-shares that have created the land registration map and address, and by receiving a endorsement for the created unit-share ledger through at least one or more blockchain nodes 100 that perform the endorsement.

Next, the blockchain node 100 performs, in case that a trade for a specific unit-share is performed and a user who has registered ownership of the specific unit-share inputs a personal identifier (S150), an address creation process for creating an address for the registered specific unit-share by additionally allocating the input personal identifier to the address created for the specific unit-share (S160).

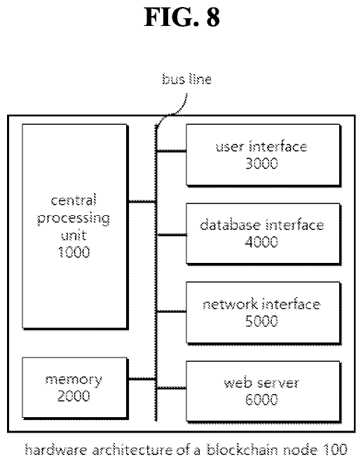

FIG. 8 shows a diagram showing a hardware architecture for a blockchain node of the system for splitting a share from a common asset and generating a land registration map and address according to an embodiment of the present inventive concept.

As shown in FIG. 8, the hardware architecture of the blockchain node 100 in a system 10 for splitting a common asset into a plurality of shares and generating a land registration map and address is configured to comprise a central processing unit (i.e., a processor) 1000, a memory 2000, a user interface 3000, and a database interface 4000, a network interface 5000, a web server 6000, and the like.

The user interface 3000 is configured to provide input and output interfaces to a user by using a graphical user interface (GUI).

The database interface 4000 is configured to provide an interface between a database and the hardware of the blockchain node. The network interface 5000 is configured to provide a network connection between devices owned by a user.

The web server 6000 is configured to provide a tool for a user to access the hardware of the blockchain node via a network. Most users can remotely access the web server (i.e., web-based access) and use the public registration system 10 through the blockchain node 100.

The above-described configuration or each step of method may be implemented as computer-readable code on a computer-readable recording medium or transmitted through a transmission medium. The computer-readable recording medium is a data storage device capable of storing data that can be read by a computer system.

Examples of computer-readable recording media include, but are not limited to, databases, ROMs, RAMs, CD-ROMs, DVDs, magnetic tapes, floppy disks, and optical data storage devices. The transmission medium may include a carrier transmitted through the Internet or various types of communication channels. In addition, the computer readable recording medium may be distributed through a network coupled computer system so that the computer readable code is stored and executed in a distributed manner.

In addition, at least one or more components applied to the present inventive concept may include or be implemented by a processor such as a central processing unit (CPU), a microprocessor, etc. that perform each function of the components, and two or more of the components may be combined into a single component to perform all operations or functions for the combined two or more components. In addition, a part of at least one or more components applied to the present inventive concept may be performed by other components among these components. In addition, communication between the components may be performed through a bus.

In the above description, while preferred embodiments according to the present inventive concept have been mainly described above, the present inventive concept is not limited thereto, and each component of the present inventive concept may be changed or modified within the technical scope of the present inventive concept to achieve the same purpose and effect.

Although preferred embodiments of the present inventive concept have been illustrated and described above, the present inventive concept is not limited to the specific embodiments described above, and of course various modifications can be made by those of ordinary skill in the art to which the present inventive concept pertains without departing from the essential points of the invention as claimed in the claims, and these variant implementations should not be understood separately from the technical idea or prospect of the present inventive concept.

The method and system for splitting shares and creating land registration maps and addresses for assets of which the owner cannot be specified or ownership does not exist, according to the present inventive concept, are configured to create land registration maps for shares of common assets of which the owner cannot be identified or does not exist, create addresses for the created land registration maps, and thus allowing a user to acquire a share on the created land registration map and easily register the share of the user according to an address on the land registration map.

What is claimed is:

1. A system for registering an asset of which owner cannot be specified or ownership does not exist, in a blockchain by splitting the asset into a share and creating a land registration map and address of the share, the system comprises a blockchain node with a processor configured to:
split the asset into a plurality of unit-shares according to a predetermined splitting rule;
create the land registration map for each of the plurality of split unit-shares in the form of a cell with a specific shape on a map or a model for the asset; and
create an address by assigning a unique identifier to each of the plurality of split unit-shares,
wherein the asset is the one of which owner cannot be specified or ownership does not exist, and the created unit-share, the land registration map, and the address are respectively the unit-share-on-the-blockchain, the land registration map-on-the-blockchain, and the address-on-the-blockchain, and
wherein the system is configured to: record the unit-share-on-the-blockchain, the land-registration-map-on-the-blockchain, and the address-on-the-blockchain in the blockchain, and thereby granting public confidence to each of the registered unit-shares by shareholders-on-the-blockchain previously participating in the blockchain.

2. The system of claim 1, wherein the processor is further configured to:
create a zone by grouping at least one or more split unit-shares and classify a sector by grouping at least one or more zones, and thereby registering the zone and the sector by recording the zone and the sector in the blockchain.

3. The system of claim 1, wherein the processor is further configured to:
create a land registration map for each zone by grouping the land registration map created for each of the unit-shares, creating a land registration map for each sector by grouping the land registration map created for each of unit-shares or the created land registration map for each of zones, and thereby registering the land registration map for the entire asset by recording the land registration map for the entire asset in the blockchain.

4. The system of claim 2, wherein the processor is further configured to:
create an address for each of the plurality of split unit-shares, by assigning a unique identifier to each unit-share, wherein the unique identifier includes a zone identifier assigned to a corresponding zone that each unit-share is grouped, a sector identifier assigned to a corresponding sector that each zone is grouped, and an asset identifier assigned to the asset itself.

5. The system of claim 1, wherein the unique identifier comprises each unit-share identifier assigned to the plurality of split unit-shares, and
the address is composed by additionally assigning an input personal identifier to the unique identifier assigned for a specific unit-share, wherein the input personal identifier is entered by a user for the registration, when the user registers ownership of the specific unit-share among a plurality of unit-shares previously recorded and registered in the blockchain.

6. The system of claim 1, wherein the processor is further configured to:
create a unit-share ledger for each split unit-share including the created land registration map, location information of each split unit-share located on the created land registration map, and the address created for each unit-share; and
register each split unit-share in the blockchain by obtaining an endorsement from at least one or more of blockchain nodes for the created unit-share ledger, and creating a block for each unit-share ledger and recording the block in the blockchain,
wherein the created block is connected to the blockchain based on a hash value obtained by hashing the address created for each unit-share and distributed and stored in the at least one or more of blockchain nodes.

7. The system of claim 1, wherein the asset is the one of which owner cannot be specified or does not exist, comprising a planet including Mars, Mercury, or the Moon; a specific area of the Earth, including the South Pole, the North Pole, or deep sea; or a combination thereof.

8. A method for registering an asset of which owner cannot be specified or ownership does not exist, in a blockchain by splitting the asset into a share and creating a land registration map and address of the share, the method comprises:
in a system for registering the asset, splitting the asset into a plurality of unit-shares according to a predetermined splitting rule;
in the system for registering the asset, creating the land registration map for each of the plurality of split unit-shares in the form of a cell with a specific shape on a map or a model for the asset; and
in the system for registering the asset, creating an address by assigning a unique identifier to each of the plurality of split unit-shares,
wherein the asset is the one of which owner cannot be specified or ownership does not exist, and the created unit-share, the land registration map, and the address are respectively the unit-share-on-the-blockchain, the land registration map-on-the-blockchain, and the address-on-the-blockchain, and
wherein the method comprises recording the unit-share-on-the-blockchain, the land-registration-map-on-the-blockchain, and the address-on-the-blockchain in the blockchain, and thereby granting public confidence to each of the registered unit-shares by shareholders-on-the-blockchain previously participating in the blockchain.

9. The system of claim 8, wherein the splitting of the unit-share further comprises:
creating a zone by grouping at least one or more split unit-shares and classify a sector by grouping at least one or more zones, and thereby registering the zone and the sector by recording the zone and the sector in the blockchain.

10. The system of claim 8, wherein the creating of the land registration map further comprises:
creating a land registration map for each zone by grouping the land registration map created for each of the unit-shares, creating a land registration map for each sector by grouping the land registration map created for each of unit-shares or the created land registration map for each of zones, and thereby registering the land registration map for the entire asset by recording the land registration map for the entire asset in the blockchain.

11. The system of claim 9, wherein the creating of the address further comprises:
creating an address for each of the plurality of split unit-shares, by assigning a unique identifier to each unit-share, wherein the unique identifier includes a zone identifier assigned to a corresponding zone that each unit-share is grouped, a sector identifier assigned to a corresponding sector that each zone is grouped, and an asset identifier assigned to the asset itself.

12. The system of claim 8, wherein the method further comprises:
creating a unit-share ledger for each split unit-share including the created land registration map, location information of each split unit-share located on the created land registration map, and the address created for each unit-share; and
registering each split unit-share in the blockchain by obtaining an endorsement from at least one or more of blockchain nodes for the created unit-share ledger, and creating a block for each unit-share ledger and recording the block in the blockchain,
wherein the created block is connected to the blockchain based on a hash value obtained by hashing the address created for each unit-share and distributed and stored in the at least one or more of blockchain nodes, and
wherein the asset is an asset of which owner cannot be specified or does not exist, comprising a planet including Mars, Mercury, or the Moon; a specific area of the Earth, including the South Pole, the North Pole, or the deep sea; or combinations thereof.
